(19) United States
(12) Patent Application Publication
(10) Pub. No.: US 2010/0255778 A1
(43) Pub. Date: Oct. 7, 2010

(54) Bluetooth Connections

(75) Inventors: Thomas Lovell, London (GB); Lucy Carroll, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Symbian Software Limited, London (GB)

(21) Appl. No.: 12/305,838

(22) PCT Filed: Jun. 26, 2007
(86) PCT No.: PCT/GB2007/002371

§ 371 Date: Jun. 15, 2010

(30) Foreign Application Priority Data
Jun. 29, 2006 (GB) 0612939.9

(51) Int. Cl. H04B 7/00

(52) U.S. Cl. 455/41.2

(57) ABSTRACT

An improved method of forming connections between Bluetooth devices is provided. A first device maintains a contacts database wherein the addresses of further Bluetooth devices are stored in the same records as the owners of those devices. When the first device wishes to connect to the device belonging to any persons in the contacts database, it simply retrieved the address from the database and starts sending Bluetooth packets; this eliminates the discovery and name request steps from the Bluetooth protocol, saving time and power.

This invention discloses an improved method of making a connection over a Bluetooth wireless link.

The term ‘computing device’ includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of such devices, together with many other industrial and domestic electronic appliances.

Bluetooth is a technology enabling various types of computing devices to be interconnected for a variety of purposes, using short-range wireless links. Full details appear on the official Bluetooth web site, http://www.bluetooth.com. It was originally conceived as a method for replacing the many cables that are traditionally used to link devices together, with the aim of both reducing the physical overhead of cabled connections, and also facilitating the ad-hoc connection of small mobile battery-operated devices whose owners could not be expected to physically carry multiple cables and connectors with them.

As such, Bluetooth has gained wide acceptance, particularly for users of mobile telephones, where the elimination of physical cabling has spawned a mini-industry devoted to the manufacture of Bluetooth headsets and handsfree devices; and for advanced smartphone users, Bluetooth has made synchronisation of phone data with computer data easier.

However, the physical nature of cabling does have certain benefits. Physical cabling is easily understood and easily installed; clear labelling of plugs and sockets, with specialised types of connectors that help to avoid damaging modules and components which are electrically incompatible, may require certain organisation and layout skills, but present few conceptual problems. The physical connections mirror our picture of the flow of signals and energy around the system. Importantly, no initialization phase is needed with any type of physical cable; just plug in, switch on and test out.

Unfortunately, the advantage brought by Bluetooth, that it eliminates the need to carry many different types of physical cable, is gained at the expense of ease of use and comprehensibility. Instead of readily understandable physical point-to-point connections, Bluetooth brings a short-wave wireless broadcast system, with one single communications channel being used for all devices for all purposes.

The physical labelling of modules and sockets is replaced by the concept of logical identities, and the bespoke connections that enable compatible outlets to be instantly mated together is replaced either by what many users consider to be a mysterious discovery process, by which the pet names accorded by the owners of every Bluetooth device in the near vicinity, which are often unknown to the device user seeking to make a connection, laboriously appear on the screen for the user to be asked to pick the one to which they want to connect, or by a prior pairing of two devices in order that they may remember each other's identities and authenticate any future connections.

The problems this causes are discussed by Parkinnen and Karvonen in their paper “Group Awareness in Bluetooth”, which can be found at http://www.tml.tkk.fi/Research/TeSSA/Papers/Parkkinen-Karvonen/Group_Awareness.pdf, while an analysis of Bluetooth usability by Northstream can be found at http://www.incodewireless.com/media/whitepapers/2002/bluetoothusabilitywhitepaper.pdf.

It is known that these Bluetooth usability concerns are in sharp contrast not just to technologies using physical cables, but also other wireless technologies, notably those incorporating infra-red protocols. These are generally regarded as being easier to use, especially for point-and-send (or beaming) operations in which a file or some other object (for instance, contact or agenda/appointment information in the form of a standard vCard or vCalendar object as defined by the Internet Mail Consortium) is transmitted from one device to another.

Some of the main areas of difficulty with making connections to remote Bluetooth devices are:
1. The discovery process itself is non-deterministic, in that the user may have to try a number of times before finding the device they want.
2. Many devices will only keep a permanent record of Bluetooth devices it has previously paired with, even though pairing is not always required for service level connections or point-and-send operations.
3. When a device is discovered, it has a name set by the remote user, which may or may not mean something to the local user. This makes it difficult for the local user to know which device to connect to without having first paired with that device and creating a name for it which is meaningful to the local user.
4. While device pairing should be used as a necessary security step, existing Bluetooth implementations force users to invoke pairing as a way of storing information about a remote device. As described above, this is because most devices only support creating a local name for remote devices that have been paired. This should not be necessary if the service that remote device supports does not require authentication.
5. Remote Bluetooth devices are generally abstract things to the user after the discovery process. The Class of Device (CoD) is the only hint at what a remote device does without actually connecting to it and performing a query using the Service Discovery Protocol (SPD). However, connection to the remote devices will be for a specific set of services or tasks; there is a clear mismatch between what the user can easily find out, and what they need to know.

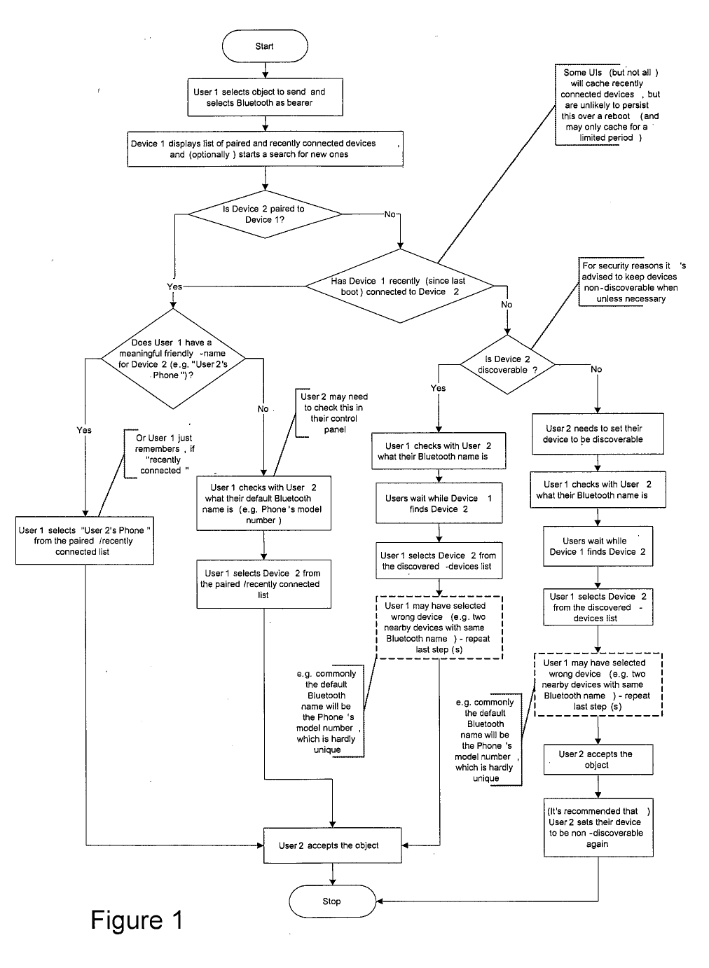

The existing procedures for discovering Bluetooth devices and sending an object, in the case of User1 owning Device1 sending to User2 owning Device2, are shown diagrammatically in FIG. 1. The benefits of having prior knowledge of a Bluetooth device can be clearly seen when pairing (which is, in the prior art, the only way of persisting known devices) is contrasted with the discovery of unknown devices. FIG. 1 clearly shows how complex the discovery process can be, and how many points of failure and uncertainty exist; and especially for the user when considering that the most commonly used Bluetooth user name is the device model number, which invariably is not unique when more than a few devices are within range.

There are prior attempts to remedy some of these deficiencies. For example, Palm have provided sample code at

http://www.palmos.com/dev/tools/bluetooth/codesamples.html that claims the following benefits:

“Several groups, including the Bluetooth SIG, have identified inquiry and discovery as one of the greatest annoyances to end users. This sample incorporates five significant usability improvements:
The device list is pre-populated with “Favorites” that the user has previously selected
Inquiry and discovery results are returned the instant they become available.
A progress bar gives the user a good indication of how long the process will take.
Device names are cached.
The user can make a selection before the process is completed.”

According to a first aspect of the present invention there is provided a method of operating a first computing device having Bluetooth capability and a contacts database, wherein the address of a second computing device having Bluetooth capability and an owner is included in that record in the contacts database of the first computing device in which the personal details of the owner of the second computing device are stored and wherein the said address is subsequently retrieved and used by the first computing device to directly initiate a Bluetooth connection with the second computing device.

According to a second aspect of the present invention there is provided a computing device arranged to operate in accordance with a method of the first aspect.

According to a third aspect of the present invention there is provided an operating system for causing a computing device to operate in accordance with a method of the first aspect.

Embodiments of the present invention will now be described, by way of further example only, with reference to the accompanying drawings in which:—

FIG. 1 shows a comparison of the steps followed when connecting to a known device and an unknown device;

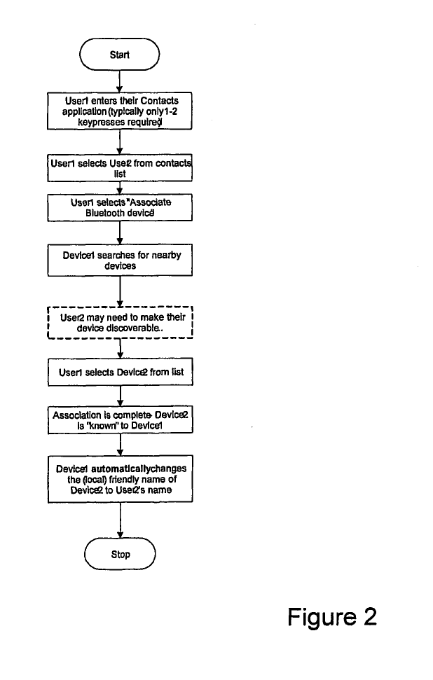

FIG. 2 shows a method of connection in accordance with an embodiment of the present invention;

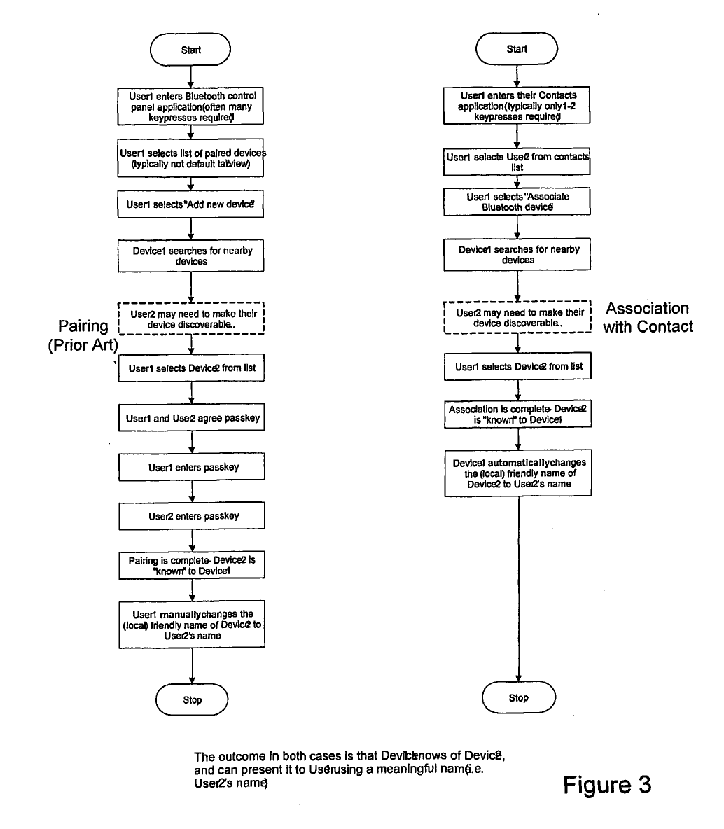

FIG. 3 shows the steps followed in establishing a connection in accordance with the method of FIG. 2 in comparison to the method of connecting to a known device as shown in FIG. 1;

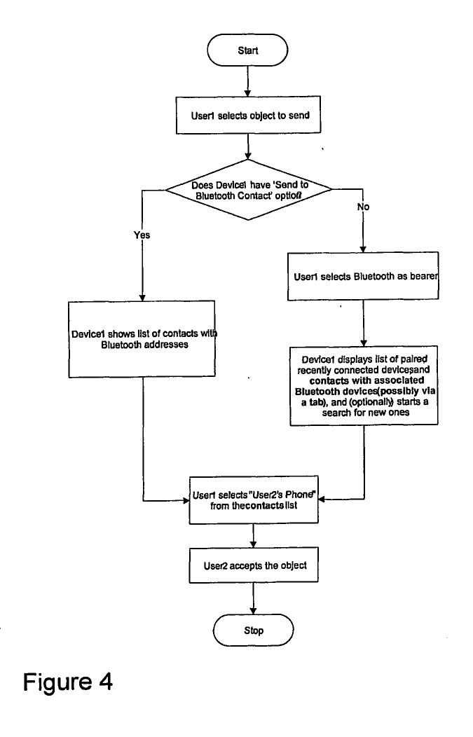

FIG. 4 shows a method of sending an object to a device in accordance with the present invention; and

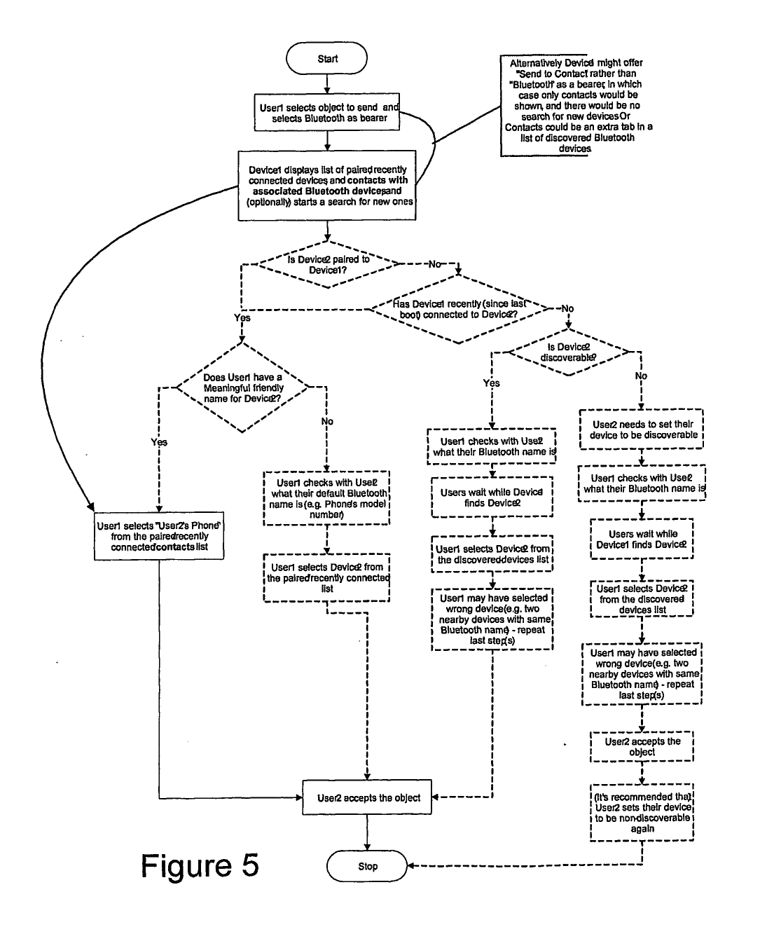

FIG. 5 shows a method of sending an object as illustrated in FIG. 4 in comparison to a known method of sending an object.

This invention discloses a completely different method of substantially alleviating the Bluetooth usability and technical problems described above, which is more intuitively obvious to the user and is more lightweight in operation even than pairing.

A key perception behind this invention is that a computing device which maintains a database of personal contacts, such as an address book, can store details of the Bluetooth devices owned or used by those contacts in that database, and that this novel combination of information can in turn be used to implement a novel and particularly advantageous method of connecting two Bluetooth devices, which is ideally suited for simple point-and-send operations. The method of this invention is predicated on the fact that provided the address of an active Bluetooth device is known in advance, a sender can begin to transmit data packets to it without any prior negotiation.

Computing devices which maintain databases of personal contacts include mobile telephones and PDAs; the Personal Information Manager (PIM) applications on such devices are typically able to store various items of information relating to personal contacts. Adding a database field for a Bluetooth device is generally a fairly straightforward operation for those who produce software for such computing devices. Indeed, in cases where the database of such an application includes an option for user-definable fields, no extra work needs to be done at all.

This invention associates mobile Bluetooth devices with their owner (mobile in this case means devices with appropriate CoD bits set e.g. Cellular Phones, Smart Phones, and PDAs). Each contact's information can contain a Bluetooth address, both when stored locally on the device and when sent to other devices. When sent to other devices, the Bluetooth address can be implemented as an extension to the industry standard vCard specification as defined by the Internet Mail Consortium in RFC 2425 and RFC 2426.

In the preferred implementation of this invention, the user interface for displaying each contact indicates whether that contact has a Bluetooth address; the Bluetooth address itself is stored in the database, but is not normally displayed as it is essentially meaningless to most users. The display may further be extended to indicate whether that person is in the vicinity of the device. Moreover, the friendly name for that Bluetooth address may be automatically updated to match the name of the contact. The presence of the Bluetooth address in the contacts database (or equivalent) ensures that the mobile device is explicitly associated with the contact.

The association between a contact and a Bluetooth device can be recorded automatically. For example, the user could receive an electronic business card (vCard) from a remote Bluetooth device over a Bluetooth connection, and elect to store the details of the card in their contacts database, in which case the Bluetooth address of the owner's device would also automatically be stored in the same record.

This automatic recording of a Bluetooth address requires that the vCard is sent from the Bluetooth device of the owner of the vCard. It is therefore proposed as part of this invention to extend the vCard specification to include Bluetooth address information, as required by a Bluetooth-user association, as an integral part of an electronic Business Card; this would additionally enable Bluetooth-user associations to be stored when a vCard was either sent over Bluetooth by a person other than the owner or else sent over a different carrier, such as an electronic mail network.

Alternatively, the association between a contact and a Bluetooth device can also be recorded manually provided that the name of the Bluetooth device is known in advance. For example, the user could select a contact record from their contacts database and initiate a Bluetooth device discovery, in which case they could select the appropriate member of the resulting list of discovered devices to be stored in the contacts database. This association between a contact and a Bluetooth address is shown diagrammatically in FIG. 2, with User1 owning Device1 adding an association between User2 owning Device2. This process commences with User 1 entering their contacts application, and typically only one or two key presses are required for this because it is a frequently used application and specifically designed to be user friendly. User 1 then selects User 2 from the contacts list held in that application. User 1 then selects “Associate Bluetooth device”. Device 1 of User 1 then searches for nearby devices. It is assumed in this example that Device 2 of User 2 has been made discoverable, and therefore, all that is now required is for User 1 to select Device 2 and the association between Devices 1 and 2 is complete. At this point, Device 1 can be arranged so that it automatically changes the friendly name of Device 2 form that selected by User 2 to a friendly name more readily recognizable to User 1, such as the name of User 2.

The simplicity of this invention when compared to the known method of pairing can be clearly seen from FIG. 3, which compares the case of User1 owning Device1 adding an association between User2 owning Device2 (Association with Contact) with the case of User1 owning Device1 pairing with User2 owning Device2 (Pairing).

This relative simplicity attributable to this invention arises from a number of reasons.
Association is initiated from the contacts application on the device, which is generally highly accessible as it is very commonly used. In contrast, pairing is generally initiated from a much less frequently used option in a control panel or device setup application.
There is no need to enter any passkeys, as the Bluetooth user association disclosed in this invention neither uses nor requires passkeys.

Once the association is set up, the process of sending an object to a known device over Bluetooth using the present invention is also very much simplified over any prior art. This process is shown in FIG. 4. In all cases, a user wishing to send an object needs to select the object to be sent. Two case scenarios are shown, and it is possible in the best case, to send the object in only two user operations. This best cases shown in the left hand branch in FIG. 4 and assumes that an option to Send an Object to a Bluetooth Contact is readily available. If this is the case, to send an object a user needs only to:
1. Select the option Send an Object to a Bluetooth Contact; this displays a list of those contacts with whom Bluetooth devices are associated with the device of User 1.
2. Selecting the appropriate contact sends the object to the selected device whose Bluetooth address is stored in the contact record.

In the alternative case where no such option exists, an extra operation is required. The User
1. Selects the option to Send.
2. Selects an option to Send over Bluetooth; this displays a list of paired devices, any cached devices which have been detected previously, and also displays a list of those contacts with whom Bluetooth devices are associated. This option may (depending on the device) initiate a Bluetooth discovery process, which is not relevant or necessary for this invention.
3. Selecting the appropriate contact sends the object to the device with the Bluetooth address stored in the contact record.

This alternative case is shown by the right hand branch in FIG. 4.

The nature of the improvement this invention offers over the prior art in sending objects between devices can clearly be seen from FIG. 5, by which the prior art cases of User1 owning Device1 sending an object to User2 owning Device2 can be compared with the case using this invention. The steps necessary for the known method are indicated with dotted lines, whereas the steps using this invention are shown with solid lines. The most significant improvements can be seen in the case of a new connection to an undiscoverable unpaired device

The application of this invention to computing devices offers a number of advantages:
It allows receiving users to be connected to by contacts that know of them without having to be discoverable, and allows transmitting users to connect to known contacts without needing to perform a discovery. This elimination of the discovery process is quicker, less intrusive and importantly provides technical benefits in device operation, such as reduced processing and power saving. These technical benefits accrue not just on the devices involved in the connection but on all Bluetooth radios in the vicinity. Any development that saves power on mobile devices which run on limited battery power is immediately highly beneficial to users, and taking a wider perspective, all power saving on any type of device helps to reduce the impact of technology on the global environment.
It allows power and time saving even for a normal discovery process; this is because when the Bluetooth address of a discovered device matches an entry in the contacts store, the name request portion of the discovery protocol can then be eliminated; using the contact name as the name of the device is not only more efficient but also more meaningful. The discovery process becomes, therefore, much more user friendly.
When compared with pairing, there is much less configuration required by the user. Apart from the elimination of passkeys, there are considerable advantaged when a local (friendly) name is automatically set based on the contact details instead being set either by often-unchanged model or by names which mean nothing to the local user.
It allows for simplification of a Bluetooth UI. Instead of offering a user a single list of Bluetooth devices (perhaps separated into different device classes) it allows a UI to be logically divided between those actions that will cause interaction with another user (devices owned by contacts are selected from the contacts application), and those that only involve accessing a service on another device (which should be configured from those applications that use that service). Selection of devices for particular purposes therefore becomes easier: users can clearly see those mobile devices that belong to other people and to distinguish them clearly from those devices (such as Bluetooth headsets and printers) that are only used for their services. As well as solving some of the well-known usability problems with Bluetooth, this makes certain types of application, such as multi-player gaming over Bluetooth, much easier to program and to use; a device can be arranged to maintain a list of friends or fellow-players for easy connection.
A normal Bluetooth discovery process becomes much more meaningful if the address of a discovered device can be matched against a previously associated contact. Furthermore, this invention allows device discoveries to be filtered based on matches with addresses stored in contacts; unknown devices can be eliminated from a list of Bluetooth devices in the vicinity. Many use cases can make use of this feature; for example, it could be used to indicate whether any acquaintances are in a crowded place by scanning for their known Bluetooth devices. Alternatively, the presence of specific contacts in such a place could be ascertained by ‘paging’ or ‘pinging’ the Bluetooth address of their mobile devices.
Bluetooth connections can realistically be included in multi-device applications which are agnostic of bearer. Such applications can automatically try each available address type that a contact has (such SMS, Email, MMS, Bluetooth, SIP, Instant Messaging) in either a pre-defined order or rule based order.

Although the present invention has been described with reference to particular embodiments, it will be appreciated that modifications may be effected whilst remaining within the scope of the present invention as defined by the appended claims.

1. A method of operating a first computing device having Bluetooth capability and a contacts database, wherein the address of a second computing device having Bluetooth capability and an owner is included in that record in the contacts database of the first computing device in which the personal details of the owner of the second computing device are stored and wherein the said address is subsequently retrieved and used by the first computing device to directly initiate a Bluetooth connection with the second computing device.

2. A method according to claim 1 wherein the display of a record from the contacts database of the first computing device includes an indication of whether a Bluetooth address of a second computing device is stored in that record.

3. A method according to claim 1 or claim 2 wherein the first computing device is enabled to display the name of the contact as the Bluetooth name of the second computing device.

4. A method according to any one of claims 1 to 3 wherein the first computing device is enabled to store the Bluetooth address of the second computing device.

5. A method according to claim 4 wherein the Bluetooth address of the second computing device is obtained while the first computing device is connected to the second computing device over Bluetooth or is included in an electronic business card sent to the first computing device.

6. A method according to claim 5 wherein the electronic business card is a vCard and wherein the Bluetooth address is included in a field in the vCard reserved for this purpose.

7. A method according to claims 1 to 3 wherein the user of the first computing device stores the Bluetooth address of the second computing device subsequent to a manual Bluetooth discovery of the second computing device.

8. A method according to any one of the preceding claims wherein the first computing device is arranged to include a dedicated control for the purpose of sending an object to any second computing device whose owner and Bluetooth address are both included in the same record in the contacts database of the first computing device.

9. A method according to any one of the preceding claims wherein the first computing device is enabled to display a list of all contacts with Bluetooth address whenever the owner of the device indicates that they wish to initiate a Bluetooth connection.

10. A method according to any one of the preceding claims wherein the retrieval of a Bluetooth address from the contacts database enables the first computing device to eliminate either one or both of the Bluetooth discovery procedure or the Bluetooth name request procedure.

11. A method according to any one of the preceding claims wherein the first computing device is enabled to use the Bluetooth addresses stored in the contacts database to differentiate personal Bluetooth devices from those which offer a service.

12. A method according to any one of the preceding claims wherein the Bluetooth address of the second computing device stored in the contacts database of a first computing device is used by the owner of the first computing device to determine the presence of the owner of the second computing device.

13. A computing device arranged to operate in accordance with a method as claimed in any one of claims 1 to 12.

14. An operating system for causing a computing device to operate in accordance with a method as claimed in any one of claims 1 to 12.
